(19) United States
(12) Patent Application Publication
(10) Pub. No.: US 2025/0149944 A1
(43) Pub. Date: May 8, 2025

(54) Liquid-Cooled Stator with End Turn Shrouds

(71) Applicant: BorgWarner Inc., Auburn Hills, MI (US)

(72) Inventors: Kirk Neet, Noblesville, IN (US); Matthew Ryan Conner, Franklin, IN (US); Attila Nagy, Fishers, IN (US)

(21) Appl. No.: 18/939,408

(22) Filed: Nov. 6, 2024

Related U.S. Application Data
(60) Provisional application No. 63/596,851, filed on Nov. 7, 2023.
(60) Provisional application No. 63/596,865, filed on Nov. 7, 2023.

(51) Int. Cl. H02K 3/24; H02K 9/19

(52) U.S. Cl. CPC H02K 3/24; H02K 9/19

(57) ABSTRACT

A liquid-cooled stator for an electric machine includes a stator core positioned within a housing. The housing includes a plurality of teeth and a back iron, the plurality of teeth defining an inner diameter (ID) of the stator core, and the back iron defining an outer diameter (OD) of the stator core. A winding arrangement is positioned on the stator core and includes a first plurality of end turns extending from a first axial end of the stator core and a second plurality of end turns extending from a second axial end of the stator core. A shroud is positioned on the first axial end of the stator core and covers the first plurality of end turns. An inner sleeve is connected to the ID of the stator core and extends in an axial direction beyond a first axial end of the stator core.

### CROSS-REFERENCE TO RELATED APPLICATIONS

This application claims priority from U.S. provisional patent application No. 63/596,851, filed Nov. 7, 2023, and U.S. provisional patent application No. 63/596,865, also filed Nov. 7, 2023, the entire contents of which are incorporated herein by reference.

### FIELD

The present disclosure relates to the field of electric machines, and more particularly, to fluid cooled stators for electric machines.

### BACKGROUND

Electric machines must be operated under controlled temperature conditions for efficient operation. This is particularly true for electric machines with high torque output, such as those used in electric vehicles and hybrid-electric vehicles. Thermal-management/cooling systems are employed in these vehicles to control the temperature of the electric machine, and particularly the temperature of the stator windings. Examples of such thermal management systems include those that utilize oil-drip cooling tubes to deliver cooling oil to the stator as well as flooded stator designs. Unfortunately, these prior art thermal management systems for vehicle electric machines are often inefficient. Oil-drip cooling systems are often limited by a poor heat-transfer coefficient (HTC) and high pressure drop. Flooded stators are also limited by a low HTC. For example, in flooded stators with segmented windings, the tightly bundled and varnished end turns do not provide sufficient surface area for a high HTC. Moreover, prior art flooded hairpin stators typically utilize complicated and expensive methods to seal the stator.

In view of the foregoing, it would be advantageous to provide a thermal management system for a stator with a high HTC. Additionally, it would be advantageous if such thermal management system was relatively simple and could be implemented inexpensively in a flooded hairpin stator.

### SUMMARY

In at least one embodiment, a liquid-cooled stator for an electric machine includes a housing, a stator core, a winding arrangement, a shroud, and an inner sleeve. The stator core is positioned within the housing and includes a plurality of teeth and a back iron, the plurality of teeth defining an inner diameter (ID) of the stator core, and the back iron defining an outer diameter (OD) of the stator core. The winding arrangement is positioned on the stator core and includes a first plurality of end turns extending from a first axial end of the stator core and a second plurality of end turns extending from a second axial end of the stator core. The shroud is positioned on the first axial end of the stator core and covers the first plurality of end turns. The inner sleeve is connected to the ID of the stator core and extends in an axial direction beyond a first axial end of the stator core.

In at least one additional embodiment, a liquid-cooled stator for an electric machine includes a housing, a stator core, a winding arrangement and a shroud. The stator core is positioned within the housing and includes a plurality of teeth and a back iron. The winding arrangement is positioned on the stator core and includes a plurality of end turns extending from an axial end of the stator core. The shroud is positioned on the axial end of the stator core and covers the plurality of end turns. The shroud further includes a corrugated radial wall defining an axially-outward face.

In yet another embodiment, a liquid-cooled stator for an electric machine comprises a stator core, a winding arrangement, and shroud with an undercut. The stator core is positioned within the housing and includes a back iron defining an outer diameter (OD) of the stator core and a plurality of teeth defining an inner diameter (ID) of the stator core and an inner cylindrical space. The winding arrangement is positioned on the stator core and includes a plurality of end turns extending from an axial end of the stator core, wherein the end turns bow radially-outward toward the OD. The shroud is positioned on the axial end of the stator core and covers the plurality of end turns. The shroud further includes an undercut along an outer wall of the shroud in proximity of the stator core such that a radial distance from the inner cylindrical space to the outer wall of the shroud is less at the undercut than at positions axially-outward from the undercut.

The above described features and advantages, as well as others, will become more readily apparent to those of ordinary skill in the art by reference to the following detailed description and accompanying drawings. While it would be desirable to provide an electric machine that provides one or more of the forgoing or other advantageous features as may be apparent to those reviewing this disclosure, the teachings disclosed herein extend to those embodiments which fall within the scope of the appended claims, regardless of whether they include or accomplish one or more of the advantages or features mentioned herein.

### BRIEF DESCRIPTION OF THE DRAWINGS

FIG. 1 is a side view of an electric machine including a liquid-cooled stator with end-turn shrouds;

FIG. 2 is a cross-sectional cutaway view of the stator for the electric machine of FIG. 1 showing a winding arrangement on as stator core;

FIG. 3 is a top perspective view of the stator core of FIG. 2 in isolation from the winding arrangement;

FIG. 4A is a top perspective view of the stator core of FIG. 3 with the winding arrangement positioned thereon, the winding arrangement including diamond-shaped coils;

FIG. 4B is an enlarged view of the portion of the stator within isolation box B of FIG. 4A;

FIG. 5 is a side perspective view of a diamond-shaped coil of the winding arrangement of FIG. 4A, the coil including in-slot segments, end-turns, and coil leads;

FIG. 6 is a lead-end perspective view of the stator of FIG. 1 with the lead-end shroud removed from the stator core to expose a lead guide;

FIG. 7 an enlarged perspective view of the lead guide on the stator of FIG. 6;

FIG. 8 is a cross-sectional cutaway view of the lead-end shroud of FIG. 6 illustrating placement over end turns of the winding arrangement and a connection to the stator core and a sleeve that extends along an inner diameter (ID) of the stator;

FIG. 9 is a cross-section illustration of a plastic reinforcement ring included on the ID of the lead-end shroud of FIG. 8;

FIG. 10 is a crown-end perspective view of the stator of FIG. 1 with the crown-end shroud positioned on the stator core and the lead-end shroud removed from the stator core;

FIG. 11 is a cross-sectional cutaway view of the crown-end shroud of FIG. 10 illustrating the position of end turns of the diamond-shaped coils of the winding arrangement under the crown-end shroud;

FIG. 12 is an axially-outward perspective view of a portion of the crown-end shroud of FIG. 10 illustrating corrugations on the shroud;

FIG. 13 is a cross-sectional cutaway view of the crown-end shroud and end turns of the winding arrangement of the stator along line XIII-XIII of FIG. 10;

FIG. 14 is a cross-sectional cutaway view of an alternative embodiment of the crown-end shroud and end turns of FIG. 13 illustrating an undercut position on a circumferential wall of the shroud;

FIG. 15 is a perspective cross-sectional cutaway view of the crown-end shroud and end turns of FIG. 14 with the undercut incorporated into the circumferential wall of the shroud;

FIG. 16 is another perspective cross-sectional cutaway view of the crown-end shroud and end turns of FIG. 14 revealing additional portions of the shroud and the stator core;

FIG. 17 is a cross-sectional cutaway view of another alternative embodiment of the crown-end shroud and end turns of FIG. 13, wherein the shroud includes an undercut shim;

FIG. 18A shows a cross-sectional side view of outer diameter (OD) portions of the stator core of FIG. 3 illustrating differently sized lamination plates that form circumferential channels around the core;

FIG. 18B is an enlarged view of the stator OD within isolation box B of FIG. 18A;

FIG. 19 is a cross-sectional view through a first axial plane illustrating a system for delivering cooling oil to the stator of FIG. 1;

FIG. 20 is another cross-sectional view of the system of FIG. 19 through a second axial plane;

FIG. 21 is a cross-sectional side view illustration of an alternative embodiment of a system for delivering cooling oil to the stator of FIG. 1;

FIG. 22 is a cross-sectional side view illustration of another alternative embodiment of a system for delivering cooling oil to the stator of FIG. 1; and

FIG. 23 is a constant velocity diagram illustrating the flow rate of oil around the end turns with the system for delivering cooling oil of FIG. 19.

### DESCRIPTION

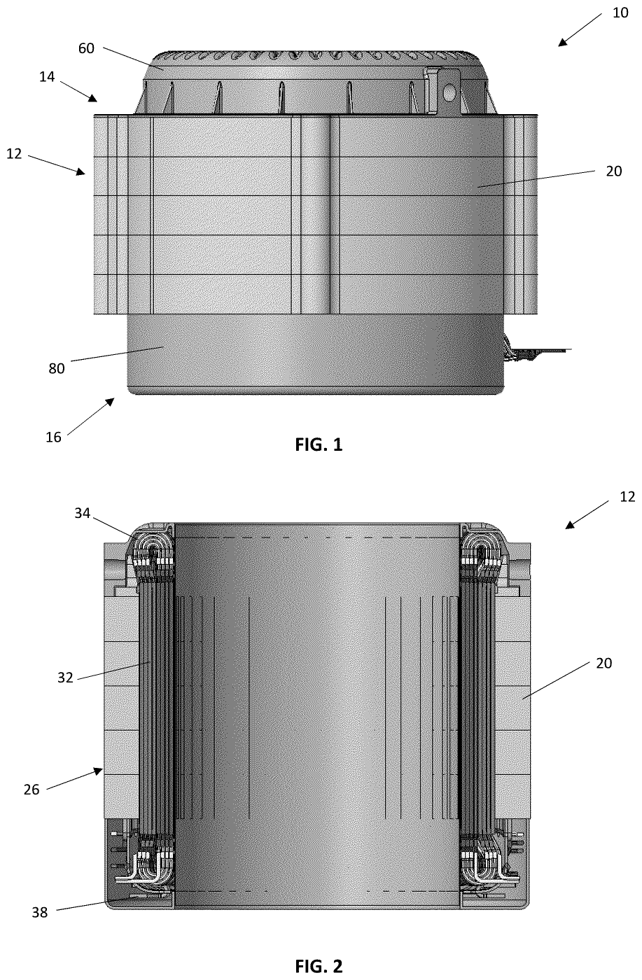

An electric machine with a liquid-cooled stator is disclosed herein. With general reference to FIGS. 1 and 2, the electric machine 10 includes a stator 12 and a rotor (not shown). The stator 12 includes a core 20 with a plurality of windings 30 arranged thereon. A first shroud 60 is positioned on a crown-end 14 of the stator core, and a second shroud 80 is positioned on the lead-end 16 of the stator core. A center sleeve 50 extends axially outward from the inner diameter (ID) 28 of the stator core on both the crown-end and the lead-end of the stator core. The first shroud 60 extends between the center sleeve 50 and the crown-end of the core 20 and covers the end turns 34 of the windings 30 on the crown-end 14 of the stator. The second end turn shroud 80 extends between the center sleeve 50 and the lead-end of the core and covers the end turns 34 of the windings on the lead-end 16 the stator. The stator 12 is configured to receive a flow of oil or other cooling liquid and direct the flow of cooling liquid to the crown-end and the lead-end of the core 20. During operation of the electric machine 10, the cooling liquid flows over the end turns 34 and cools the stator 12. The cooling liquid is contained on the crown-end and the lead-end of the stator core by the shrouds 60, 80 and the center sleeve 50.

It will be recognized that the following description of embodiments of the stator for an electric machine makes use of relative terms that are dependent on an orientation of the electric machine at a given time (e.g., during manufacture or use of the machine in a vehicle). Accordingly, it will be recognized that many terms of orientation and position as used herein are defined with reference to what may be shown in the drawing and/or other common positions. While efforts have been made herein to reference portions of the electric machine with respect to non-changing features (e.g., “axial,” “radial” and “circumferential” directions and related positions of the stator), it will be recognized that other terms are relative terms that depend on the position of the electric machine. For example, the terms “top” (or “upper”), “bottom” (or lower), “left” or “right” may be used herein in association with what is shown in a drawing, but such positions may switch or change if the electric machine is placed in a different position. As another example, the term “above” references a relative position where one component is vertically higher than another component, and the term “below” references a relative position where one component is vertically lower than another component.

### Stator Core

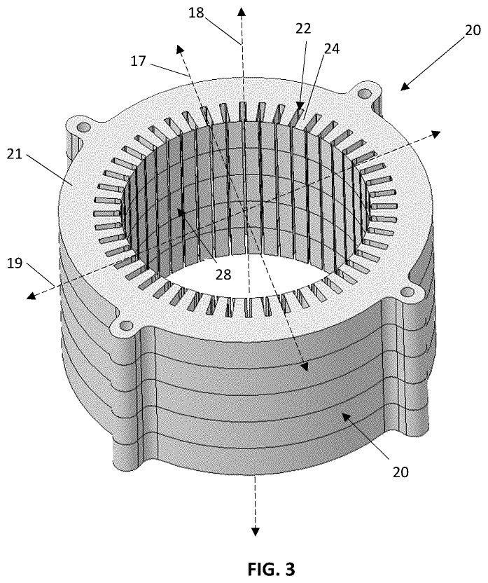

FIG. 3 shows a view of the stator core 20 in isolation from the winding arrangement 30. The stator core 20 is comprised of a magnetic-permeable material, such as steel, and is typically formed from a plurality of steel sheets that are stamped and stacked upon one another to provide the core in the form of a lamination stack. As another option, the stator core 20 may be comprised of a soft magnetic composite (“SMC”). The stator core 20 is generally cylindrical in shape as defined by a center axis 18, and includes a back iron 21 with a plurality of teeth 24 extending radially inward from the back iron 21. An outer perimeter surface of the back iron 21 defines an outer diameter (OD) of the stator. An inner perimeter surface of the teeth 24 define an inner diameter (ID) for the stator. An inner cylindrical space is also defined within the ID of the stator, and the rotor of the electric machine is positioned within this inner cylindrical space. When referenced herein, this inner cylindrical space is not limited by the axial length of the core 20, but instead extends in the axial direction from one end to the opposite end of the stator 12.

The plurality of teeth 24 extend inwardly from the back iron 21 (i.e., the teeth 24 extend from the back iron 21 toward the center axis 18). Each tooth 24 extends radially inward and terminates at the inner perimeter surface (ID). Axial slots 22 are formed in the stator core 20 between the teeth 24. Each slot 22 is defined between two adjacent teeth, such that two adjacent teeth form two opposing radial walls for one slot. The teeth 24 and slots 22 all extend from a first end 14 to a second end 16 of the core 20.

The slots 22 may be open or semi-closed along the inner perimeter surface of the stator core 20. When the slots 22 are semi-closed, each slot 22 has a width that is smaller at the inner perimeter surface than at more radially outward positions (i.e., slot positions closer to the outer perimeter surface). When the slots are open, conductors may be inserted into the slots radially via openings along the ID. In addition to the radial openings to the slots 22 through the inner perimeter surface (i.e., for open and semi-closed slots), axial openings to the slots 22 are also provided the opposite ends 14, 16 of the stator core 20.

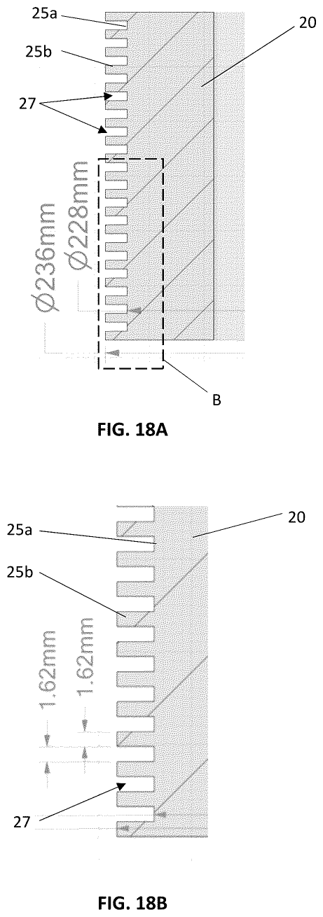

While an exemplary stator core 20 is represented in FIG. 3, it will be recognized that the stator core may also be provided in other forms. For example, in at least one embodiment described in further detail below in association with FIGS. 18A and 18B, the lamination stack may include sheets of the magnetic-permeable material having different OD sizes, thus resulting in circumferential channels formed around the core 20. In yet another embodiment, the lamination stack may be split into two halves which are spaced a part from each other in order to allow for oil or other cooling liquid to flow in between the two halves and more easily reach axially central positions on the core.

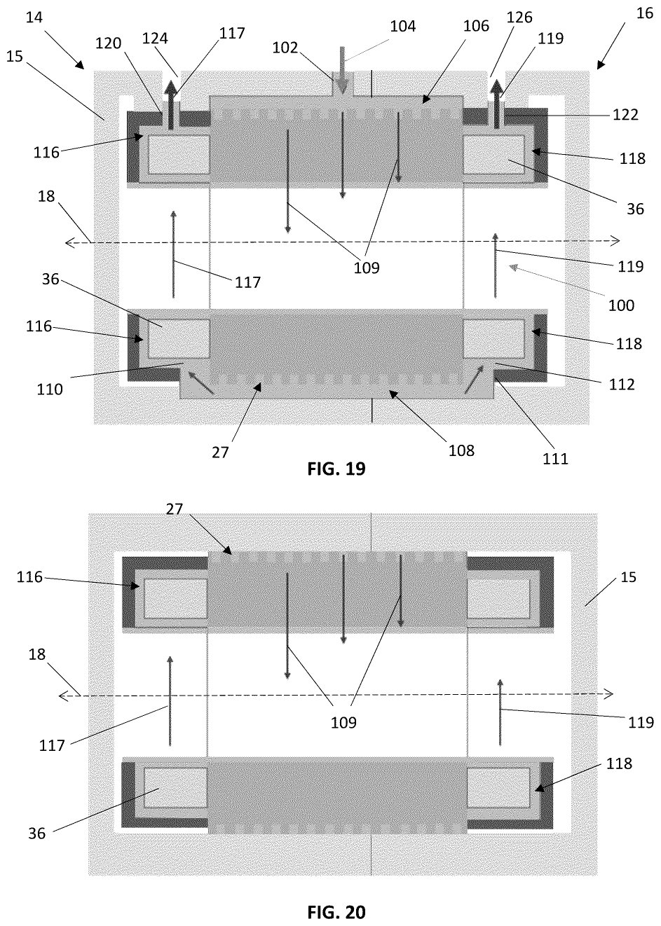

In addition to the central axis 18, FIG. 3 also illustrates axes 17 and 19, which are perpendicular to one another and also perpendicular to the central axis. As such, axes 17 and 18 lie in one cross-sectional plane, and axes 18 and 19 lie in another cross-sectional plane. These two cross-sectional planes are referenced herein in association with FIGS. 19 and 20, described in further detail below.

### Winding Arrangement

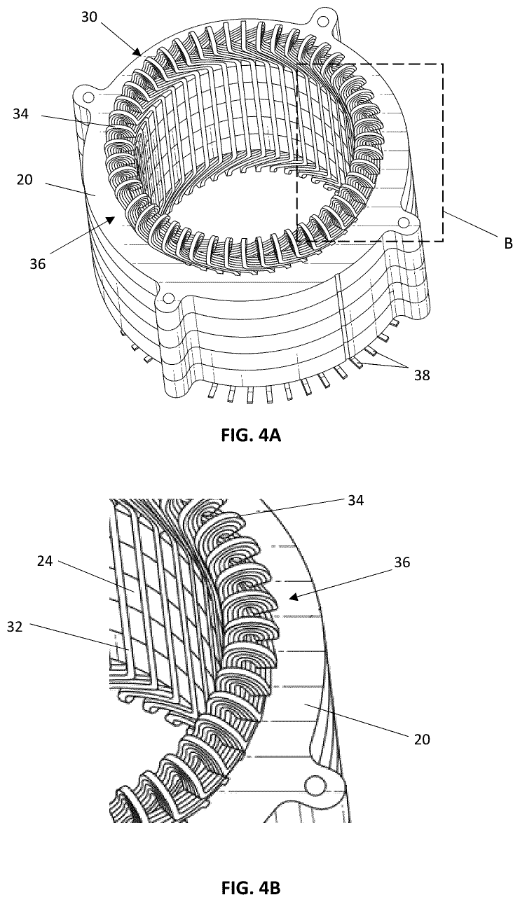

With reference now to FIGS. 4A and 4B, the stator core 20 is configured to retain the winding arrangement 30 within the slots 22 of the stator core 20. The winding arrangement 30 is formed from a plurality of interconnected conductors 32 that are retained within the slots 22. In the embodiment disclosed herein, the conductors 32 form a plurality of defined coils 40 that wrap around the teeth 24 of the core. In other embodiments, the conductors 32 may be differently configured, such as wave-windings that wind around the core.

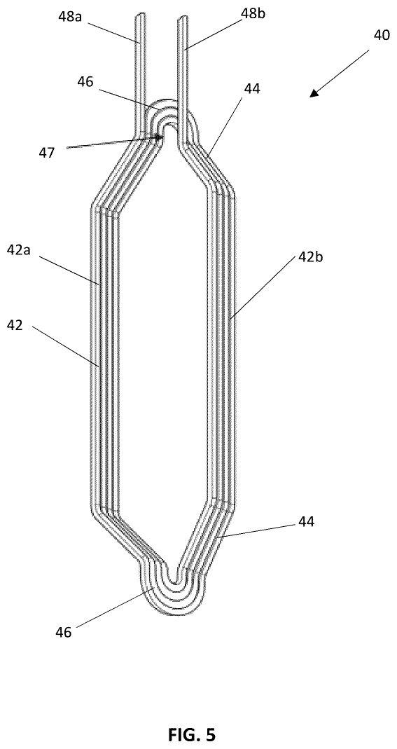

With reference now to FIG. 5, one of the coils 40 of the winding arrangement 30 is shown in isolation from the winding arrangement. As shown in FIG. 5, each coil is a diamond-shaped coil that includes a plurality of straight in-slot conductors 42, a plurality of end turns 44, and a plurality of coil leads 38. The straight in-slot conductors 42 (which may also be referred to herein as “in-slot segments” or “legs”) extend through the slots 22 from one end of the core 20 to the opposite end of the core (i.e., from the first end 14 to the second end 16). Two groups 42a and 42b of in-slot segments 42 are associated with each coil 40. Each group 42a, 42b of in-slot segments 42 extends through a different slot of the core. Multiple in-slot segments are included in each group 42a, 42b. In the embodiment of FIG. 5, each group 42a, 42b includes four in-slot segments 42. These four in-slot segments are arranged in single file within the slots 22 (i.e., in “layers” of conductors within the slot). Each slot 22 is configured to retain some number of in-slot segments in layers of the slot. In at least one embodiment, the slots 22 are configured to retain twice the number of in-slot segments 42 as the number of conductors of each group 42a, 42b (e.g., each group 42a, 42b including four in-slot conductors 42, and each slot is configured with a total of eight layers of in-slot conductors).

In addition to the in-slot segments 42, each coil 40 further includes end turns 44 and coil leads 48. The end turns 44 and coil leads 48 are provided as part of winding heads 36 of the winding arrangement 30 (see FIGS. 4A and 4B), and are therefore arranged axially beyond the respective ends 14, 16 of the stator core 20. It will be noted that reference numeral 44 is used herein to reference the end turns on one coil of the winding arrangement (such as that of FIG. 5), and reference numeral 34 is used herein to collectively refer to all the end turns of the winding arrangement (as shown in FIG. 4A).

With continued reference to FIG. 5, the end turns 44 (which may be also referred to herein as “end loops”) extend between the two groups 42a, 42b of in-slot segments. In other words, each end turn 44 provides a bridge from the end of a conductor in one group 42a to the end of a conductor in another group 42b. Each end turn 44 has a U-shaped or V-shaped structure with a first angled portion (which may also be referred to herein as a “first segment”) and a second angled portion (which may also be referred to herein as a “second segment”) that meet at a rounded tip 46. The rounded tip 46 defines the portion of the end turn where the coil 40 changes direction as it loops around the core (e.g., changing from a direction moving axially away from the core back to a direction moving axially toward to core). The rounded tip 46 of the end turn 44 forms an eyelet hole 47. Advantageously, this eyelet hole 47 is configured to allow cooling oil to easily flow around the end turns 44, as described in further detail below.

With continued reference to FIG. 5, each coil 40 includes two coil leads 48. Each coil lead 48 provides a path into or out of the looping portions of each coil 40. In other words, if the coil body is considered to include the in-slot segments 42 and the end turns 44 that form loops, the coil leads 48 provide a path leading to the coil body. FIG. 5 shows two coil leads that extend axially outward. These coil leads 48 may be bent or otherwise manipulated to provide appropriate connections between coils 40 of the winding arrangement 30.

As will be recognized from the foregoing, the coil of FIG. 5 is a diamond-shaped coil 40 that includes a strand of wire that is wrapped in a loop to include a set of left legs 42a, a set of right legs 42b, and end turns 44 on the opposing ends 14, 16 of the core. The left legs 42a and right legs 42b are all elongated in an axial direction and parallel to one another. The end turns 44 connect the legs 42 in series such that a coil 40 is formed, allowing electricity to flow from a first lead 48a at one end of the coil, through all of the legs 42, and to a second lead 48b at the same end of the coil 40. The plurality of coils 40 are connected together via the leads to form a plurality of paths for the winding arrangement 30.

In the embodiment disclosed herein, no leads 48 are provided on the first end 14 of the core, and this end may also be referred to as a “crown end.” Only end turns 44 are provided on the crown end 14 of the core 20. In contrast, all of the leads 48 of the winding arrangement 30 are provided on the second end 16 of the core, and this end may be referred to as the “lead end.” Like the crown end 14, the lead end 16 also includes a plurality of end turns 44.

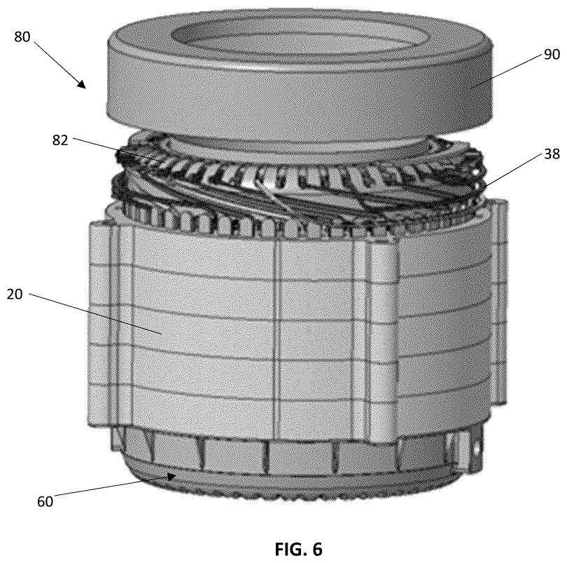

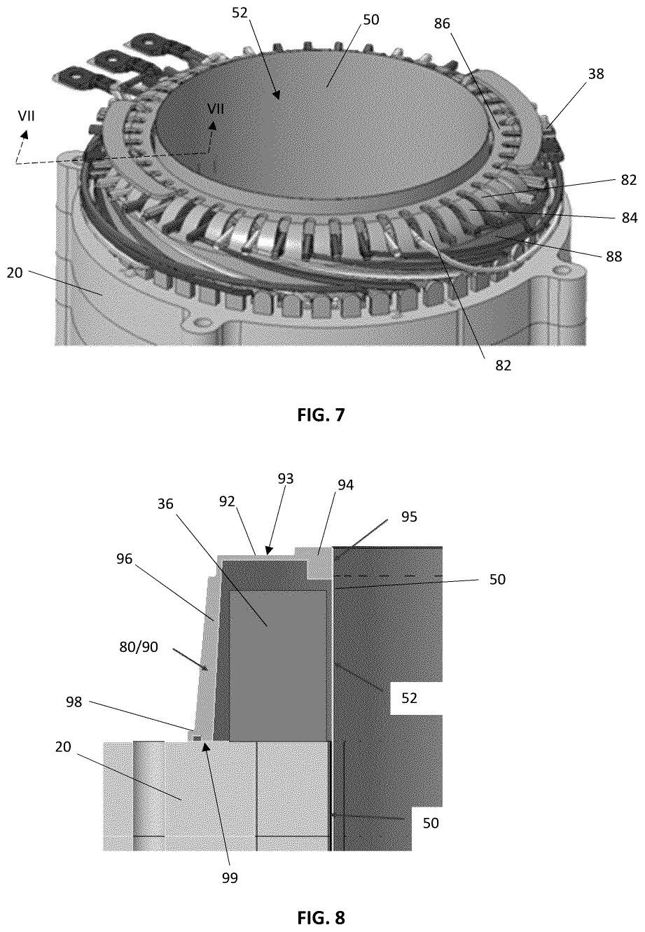

In addition to the coil leads 48, the winding arrangement 30 includes winding leads 38 located on the lead end 16 of the stator core. The winding leads 38 connect the plurality of paths for the winding arrangement in a desired configuration. Specifically, the winding leads 38 provide neutral and phase connections for the winding arrangement 30. Exemplary winding leads 38 extend circumferentially between various conductor paths, bus bars, and phase terminals, as shown in FIGS. 6 and 7. In at least one embodiment, the winding arrangement includes three phase windings (e.g., phase U windings, phase V windings, and phase W windings) with multiple paths for each phase. The three phase windings may be star (“Y”) or delta (“Δ”) connected, depending on the desired winding configuration.

With reference again to FIG. 4B, it will be noted that when the diamond shaped coils are positioned on the stator core, the rounded tips 46 of the end turns 44 are radially-aligned in groups of tips 46, and the eyelet holes 47 of each group are circumferentially aligned. The rounded tips 46 also tend bow slightly radially-outwards toward the OD when moving axially outward from the core 20. When used in association with other features of the stator 12, the rounded tips 46 and the significant surface area offered by the end turns of diamond-shaped coils facilitate cooling of the windings, as explained in further detail herein.

While diamond shaped coils formed of continuous wire lengths are disclosed herein in association with the winding arrangement 30, it will be recognized that any number of other conductors and winding configurations may be utilized. For example, in at least one embodiment, the conductors of the winding arrangement 30 are provided by segmented conductors, such as those disclosed in U.S. Pat. No. 7,348,705, issued Mar. 25, 2008. In at least one embodiment, such segmented conductors may be formed with end turns on the crown-end 14 that include a rounded tip 46, but the end turns on the lead-end 16 may be formed from the tips of axially extending leg ends that are welded together.

### Center Sleeve On Stator Core

With reference now to FIGS. 2 and 7 a center sleeve 50 is connected to the ID of the stator core 20. In at least one embodiment, the sleeve 50 is provided by a sheet of material which is rolled into an annular/cylindrical shape and then secured to the ID of the stator core 20 using an epoxy or other adhesive material.

The sheet of material used to form the sleeve 50 is comprised of a fluid-impervious material such as polyetheretherketone (PEEK), polyamide-imide (PAI), polyester film (e.g., Mylar®), or any of various other thermoplastic or other appropriate fluid-impervious materials. In at least some embodiments, the sleeve may contain additional materials, such as a meta-aramid fibers (e.g., Nomex®). For example, the sheet may be a laminate such as Nomex-Mylar-Nomex.

Because the sleeve 50 is adapted for connection to the ID of the stator core 20, it will be recognized that the sleeve 50 will be positioned in the air gap of the electric machine (i.e., in the small gap between the stator and the rotor). A typical air gap is about 0.8 mm. Therefore, the sleeve 50 should be thin and sufficiently strong to withstand the pressure of the oil (or other cooling fluid) and a vacuum created by the spinning rotor. It has been determined that the thickness of the sleeve should therefore be between 0.1 mm and 0.3 mm.

In order to form the sleeve 50, the outer side of the sleeve 50 is coated with a B-stage epoxy or other adhesive material (which material will be eventually cured to the inner surfaces of the teeth 24 and used to connect the sleeve 50 to the ID of the stator core). Thereafter, sheet of material is rolled in to the annular/cylindrical shape that forms the sleeve 50. At this point, the previously opposite ends of the sheet overlap on the sleeve 50, and these two ends are loosely held together by the adhesive material on the outer side of the sleeve (e.g., the B-stage epoxy). Where the ends of the sleeve 50 overlap, the ends may be thinned by pressing the ends together with a force sufficient to reduce the thickness of the overlapping sheet. In this manner, the overlap portion of the sleeve is not too thick (i.e., is not double the thickness). In the case where the sheet is a laminate, the sheet may be made thinner at the overlap sections such that that when the opposing ends of the sheet are overlapped, the thickness of the sleeve at the overlap is similar to that of the remainder of the sleeve.

After being rolled into the cylindrical shape that forms the sleeve 50, the cylindrical-shaped sheet of material is inserted into the inner cylindrical space defined by the ID of the stator core 20. The axial length of the sleeve 50 is greater than that of the core 20, and accordingly the sleeve 50 extends axially past the core 20 on both the crown end 14 and the lead end 16 of the stator. In at least some embodiments, the sleeve also extends axially past the end turns 34 on the crown end and the lead end of the stator. Next, after the sleeve is inserted into the inner cylindrical space of the core 20, an inner annular surface 52 the cylindrical sheet of material is pressed radially outward so the two ends slip relative to one another and create a perfect match to the ID of the stator lamination. The press may be provided by compressed air, a bladder, an expanding mandrel, or other means of providing radially outward pressure Once fully pressed to ID, the sleeve 50 is heated up to cure the B-stage epoxy and connect the outer annular surface of the sleeve 50 to the ID of the stator core 20. Thereafter, the shrouds 60, 80 are placed on each axial end of the stator and welded or adhered to the sleeve, as explained in further detail below.

While the sleeve 50 has been disclosed herein as being provided in the form of a sheet of material rolled into a cylinder, it will be recognized that the sheet may be provided in other forms in other embodiments. For example, in at least one embodiment, the sleeve is a cylinder of plastic formed by an extrusion molding process. As another example, instead of being held together by the epoxy or adhesive, the ends of the sheet may be held together by other appropriate means, such as a laser or ultrasonic weld. In still other embodiments, the two axial ends of the sleeve 50 may be folded over or cuffed to increase strength of the sleeve 50.

### Lead-End Shroud

With reference now to FIGS. 6-8 the lead-end shroud 80 is shown in association with the stator core 20 and windings 30. In the embodiment disclosed herein, the lead-end shroud 80 is comprised of two distinct parts, including an internal lead grate 82 and an outer shell 90. The internal lead grate 82 isolates each lead 38 of the winding arrangement 30 in order to facilitate connections between the leads 38. The outer shell 90 covers the lead grate 82 on the radial-outward side and the axial-outward side of the end turns. When the outer shell 90 is sealed to the center sleeve 50 and the stator core 20, as described in further detail herein, the outer shell provides a sealed volume that houses the end turns and receives a flow of cooling fluid. Both of the internal lead grate 82 and the outer shell are comprised of a comprised of a polymer or other non-conductive material (the term “non-conductive material” as used herein refers to any of various materials that do not readily conduct electricity and may be used in in electric machines to provide insulation features for the electric machine).

The lead grate 82 of the lead-end shroud 80 is an annular disc-shaped member with a plurality of ribs 84 extending between an inner perimeter ring 86 and an outer perimeter ring 88. A plurality of openings are formed between the ribs. Each rib 84 has a curvature such that the rib gradually curves in a radially outward and axially inward direction when moving along the rib from the inner perimeter ring 86 to the outer perimeter ring 88. The ribs 84 of the lead grate 82 extend over the end turns 34 on the lead-end of the stator core 20. Openings are formed between the ribs 84 and winding leads 38 extend through the openings. As best shown in FIG. 7, the openings in the lead grate 82 serve to separate the winding leads 38 from one another, thus making it easier to weld connections on the lead-end 16 of the stator. The lead grate also facilitates manipulation and routing of jumpers and other connections between the leads 38. For example, the jumpers may be routed around and rest against the outer perimeter ring when extending between two different leads. The lead grate 82 also serves to further insulate the neutral connection bars and phase terminals from the winding leads 38. At the same time, the ribs 84 in the lead grate 82 create bumps that mix the cooling fluid and prevents straight paths of fluid flow through the shroud 80.

The outer shell 90 of the lead-end shroud 80 is configured to cover the lead grate 82 and enclose the lead-end 16 of the stator core 20. The outer shell is an annular disc shaped member that includes a radial wall 92 and a circumferential wall 96. The radial wall 92 provides the axial-outermost portion of the shroud 80. The radial wall 92 extends in a radial direction, and includes an outer surface 93 that faces axially-outward from the core 20 and an inner surface that faces axially-inward. A circumferential inner lip 94 is defined along the radially-inward perimeter edge of the radial wall 92. The inner perimeter lip 94 is significantly thicker in the axial direction than the rest of the radial wall. The thick inner lip 94 provides a radially-inward facing surface 95 that is connected to the center sleeve 50. The inner lip 94 may be connected to the center sleeve 50 using any appropriate means, such as an adhesive, a laser or an ultrasonic welding. The connection between the inner lip 94 and the center sleeve provides a tight seal that is liquid-impermeable.

The circumferential wall 96 of the outer shell 90 encircles the end turns 34 on the lead-end 16 of the stator core and extends in a generally axial-outward direction from the core 20. The circumferential wall 96 provides the radial-outermost portion of the shroud 80. The circumferential wall 96 includes an outer surface that faces radially outward away from the core 20 and an inner surface that faces radially inward. A circumferential outer lip 98 is defined along the axially-inward perimeter edge of the circumferential wall 96. The outer perimeter lip 98 is significantly thicker in the radial direction than the rest of the circumferential wall 96. The thick outer lip 98 provides an axially-inward facing surface 99 that is connected to the back iron 21 of the core 20. An O-ring, adhesive or other seal is used to connect the outer lip 98 to the stator core 20. Accordingly, the connection between the outer lip 98 and the stator core includes a tight seal that is liquid-impermeable. With the outer shell 90 connected to both the core 20 and the center sleeve, the shroud encloses the end turns 34 and creates a fluid chamber on the lead end 16 of the stator core. While not disclosed herein, the outer shell 90 of the shroud 80 also includes openings for the phase terminals, and these openings are sealed (e.g., with epoxy or other sealant) to maintain a sealed fluid chamber.

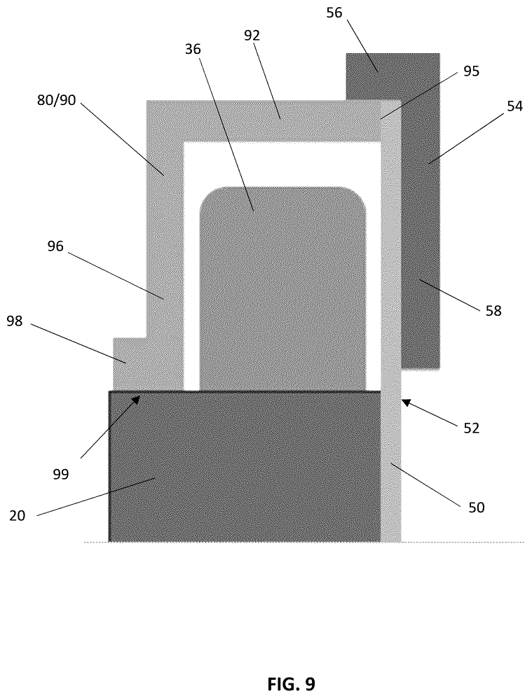

With reference now to FIG. 9, in at least one embodiment annular support ring 54 is connected to the shroud 80 and extends into the inner cylindrical space defined by the ID of the stator core 20. The support ring 54 is comprised of a plastic or other non-conductive material. The support ring 54 includes an axially-outward lip 56 and a radially-inward cylindrical portion 58. The lip 56 extends partially across and is connected to the outer surface 93 of the radial wall 92 of the outer shell 90 using any appropriate connection means (e.g., welding, adhesive, etc.). The cylindrical portion 58 extends axially downward and engages the inner annular surface 52 of the center sleeve 50. In at least some embodiments, the cylindrical portion 58 merely abuts the inner annular surface 52 and is not connected thereto. In any event, the support ring 54 provides additional support for the center sleeve 50 and prevents it from buckling under pressure when oil or other cooling liquid flows through the shroud 80.

In at least some additional embodiments, the housing 15 of the electric machine 10 may have details to compress the shroud 80 (and an O-ring or other seal) axially toward the stator core. In this embodiment, before welding the center sleeve 50 to the shroud 80, the shroud 80 may be artificially pressed to compress the O-ring to the proper height.

### Crown-End Shroud

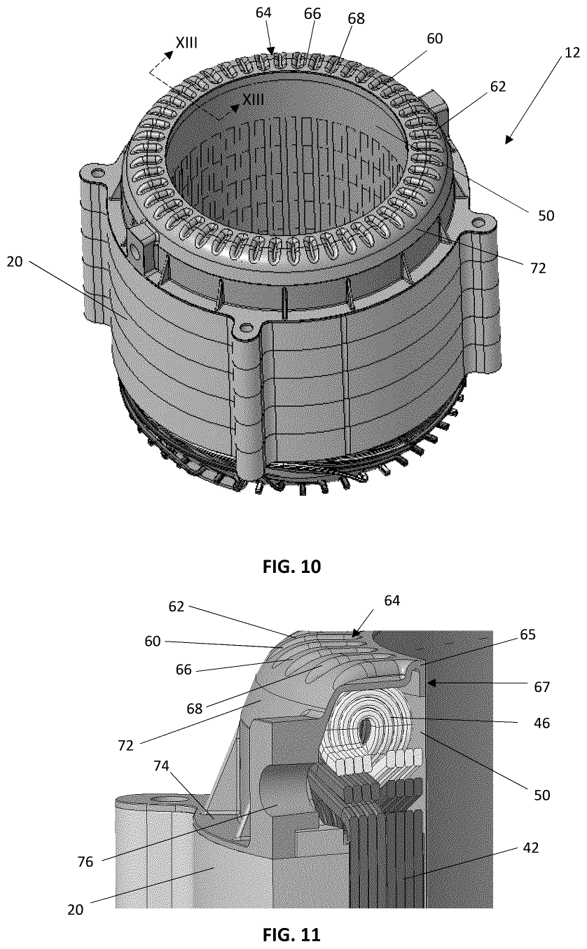

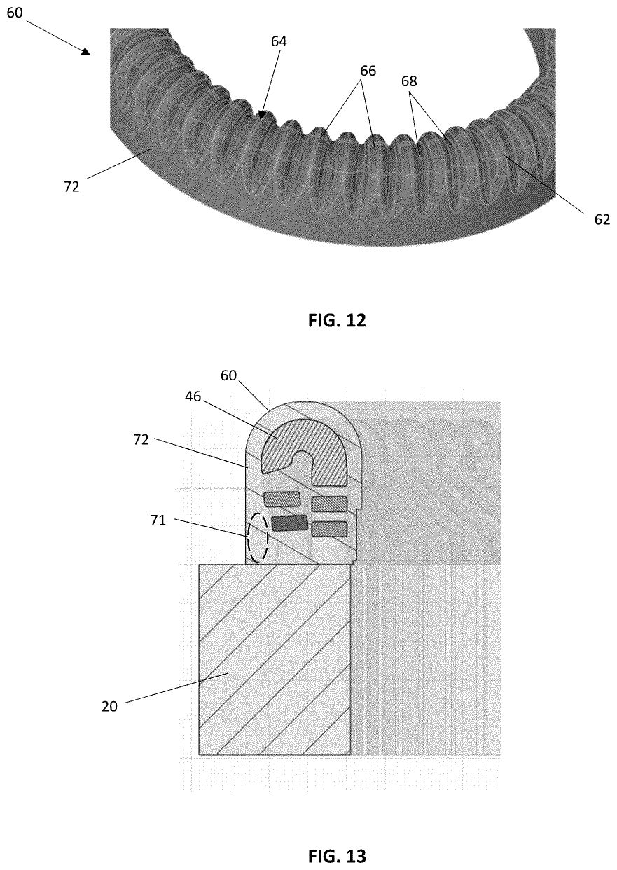

With reference now to FIGS. 10-14, the crown-end shroud 60 is arranged on the non-lead axial end of the stator core (i.e., opposite the lead-end shroud 80). Similar to the lead-end shroud 80, the crown-end shroud 60 is also a disc-like annular member comprised of a polymer (or other non-conductive material). In at least some embodiments, the shroud 60 is a unitary monolithic component. However, in other embodiments, the shroud 60 may be provided as multiple components. Similar to the shroud 80, the shroud 60 is also connected to the center sleeve 50 and the stator core 20. When sealed to the center sleeve 50 and the stator core 20, the crown-end shroud 60 defines a sealed volume that houses the end turns and receives a flow of cooling fluid.

The crown-end shroud 60 includes a corrugated radial wall 62 and a circumferential outer wall 72. The corrugated radial wall 62 provides the axial-outermost portion of the shroud 60. The corrugated radial wall 62 generally extends in a radial direction and includes a degree of curvature. The degree of curvature of the radial wall 62 is similar to that of the rounded tips 46 on the end turns 44 of the coils 40.

The corrugated radial wall 62 defines a plurality of ridges 66 and a plurality of grooves 68 on an axially-outward face 64 of the radial wall 62. The plurality of ridges 66 are positioned over (i.e., axially outward from) the rounded tips 46 on the end turns 44 of each coil 40 of the winding arrangement 30. The plurality of grooves 68 are positioned between pairs of neighboring end turns 44. The shape of the ridges 66 also follows that of the shape of the rounded tips 46. Specifically, the ridges 66 are axially and radially aligned with the rounded tips 46 and extend across some arc length defined over at least a portion of the rounded tips 46.

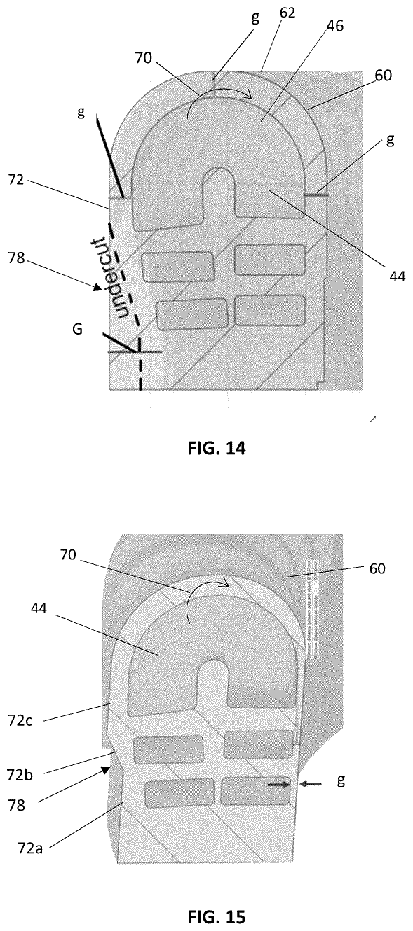

The corrugated nature of the radial wall means that the ridges 66 on the axially-outward face 64 form recesses on the axially-inward face. In this manner, the ridges are designed and dimensioned to receive the outermost parts of the rounded tips 46 of the end turns 44 with a small gap maintained between the corrugated radial wall 62 and the rounded tips. As best illustrated in FIG. 14, this small gap (g) is relatively constant space between the ridges. This gap may be, for example, 2.0-3.0 mm, with some small tolerance range (e.g., +/−2.0 mm). As a result, a relatively small constant distance (e.g., 1.0 mm<g<5.0 mm) is maintained between the rounded tips 46 and the shroud 60. Furthermore, the grooves 68 extend axially inward between the ridges 66 (i.e., into the vacant space between neighboring end turns). As a result, each groove 68 is positioned between a pair of neighboring end turns. The grooves 68 help maintain the constant distance (g) between the rounded tips 46 and the shroud 60 across a larger portion of the rounded tips 46. Together, the ridges 66 and grooves 68 encourage oil (or other cooling fluid) flowing through the shroud 60 to closely hug around the end turns 44 conductors for better cooling of the conductors. This oil flow is illustrated in FIG. 14 by arrow 70.

As best shown in FIG. 11, the shroud 60 includes a circumferential inner lip 65 defined along the radially-inward perimeter edge of the corrugated radial wall 62. The inner perimeter lip 65 is significantly thicker in the axial direction than the rest of the radial wall 62. The thick inner lip 65 provides a radially-inward facing surface 67 that is connected to the center sleeve 50. The inner lip 65 may be connected to the center sleeve 50 using any appropriate means, such as laser or ultrasonic welding. The connection between the inner lip 65 and the center sleeve 50 provides a tight seal that is liquid-impermeable.

The circumferential wall 72 of the crown-end shroud 60 encircles the end turns 34 on the crown-end 14 of the stator core and extends in a generally axial-outward direction from the core 20. The circumferential wall 72 (which may also be referred to herein as the “axially-extending sidewall” of the shroud 60) provides the radial-outermost portion of the shroud 60. The circumferential wall 72 includes an outer surface that faces radially outward away from the core 20 and an inner surface that faces radially inward. A circumferential outer lip 74 is defined along the axially-inward perimeter edge of the circumferential wall 72. The outer perimeter lip 74 is significantly thicker in the radial direction than the rest of the circumferential wall 72. The thick outer lip 74 provides an axially-inward facing surface 75 that is connected to the back iron 21 of the core 20. An O-ring, adhesive or other seal may be used to connect the outer lip 74 to the stator core 20. Accordingly, the connection between the outer lip 74 and the stator core includes a tight seal that is liquid-impermeable.

With the shroud 60 connected to both the core 20 and the center sleeve 50, the shroud 60 encloses the end turns 34 of the windings 30 and creates a fluid chamber on the crown end 14 of the stator core 20. As best shown in FIG. 11, a fluid inlet/outlet port 76 may also be included on the circumferential wall 72 to provide access to the fluid chamber defined by the shroud 60. The fluid inlet/outlet port 76 provides access to the fluid cooling paths within the stator 12.

As noted previously, the crown-end shroud 60 closely hugs the rounded tips 46 of the end turns 44 for improved conductor cooling.

This small clearance between the shroud 60 and the end turns 44 improves the cooling performance of the stator. However, because the end turns 44 of a diamond coil 40 tend to bow outwards above the end of the lamination stack, it will be recognized that larger gaps between the shroud 60 and the end turns 44 may be found closer to the stator core 20, and particularly larger gaps between the outer circumferential wall 72 and the end turn locations near the stator core. These larger gaps are illustrated in FIG. 13 by dotted line oval 71, and in FIG. 14 by the larger gap dimension “G.” Therefore, for the shroud 60 to more closely fit the end turns 44 over the entire axial length of the end turns, in at least one embodiment the shroud 60 is fitted with an undercut 78, such as the undercut illustrated by the dotted line in FIG. 14. The undercut 78 is simply a portion of the outer circumferential wall 72 that extends radially inward toward the end turns 44 near the stator core 20. FIG. 15 illustrates the shroud 60 of FIG. 14 with such an undercut 78 incorporated into the shroud 60.

The undercut 78 provided along the outer circumferential wall 72 may be provided in different forms. For example, as illustrated in FIG. 15, the undercut 78 may be provided by a three-part circumferential wall 72, including a first portion 72a extending axially-outward (upward) from the circumferential outer lip 74, a second angled portion 72b extending radially and axially outward at some angle (e.g.,) 20°-30° relative to the first portion 72a, and a third portion 72c extending axially-outward and generally parallel to the first portion 72a until it meets the corrugated radial wall 62.

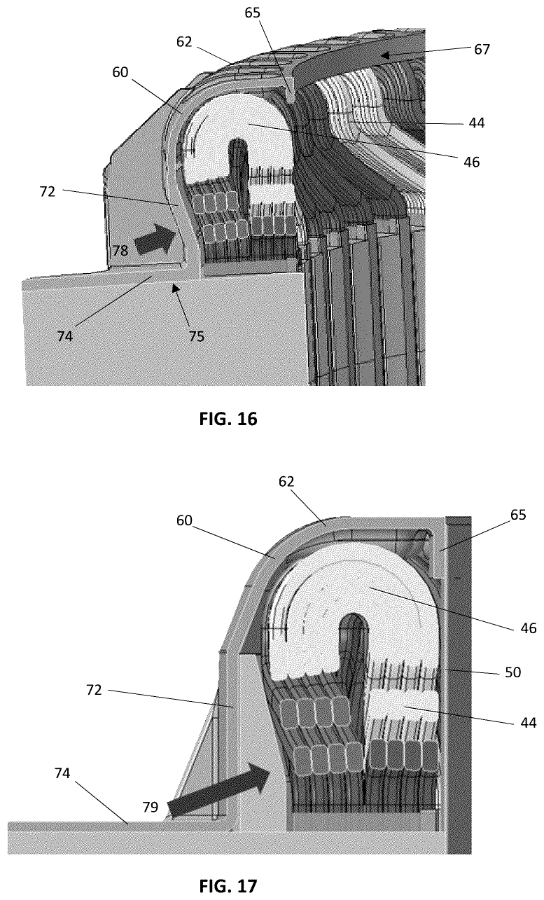

Another example of an undercut 78 is shown in FIG. 16 wherein the undercut in the outer circumferential wall 72 is provided by a more gradual curving wall. In other words, in the embodiment of FIG. 16 the undercut 78 in the outer circumferential wall is provided by a more continuous curvature and is not as easily identified by the three portions 72a, 72b and 72c of FIG. 15.

In each of the embodiments of FIGS. 15 and 16, the undercut 78 prevents the shroud 60 from being positioned over the end turns 34 of the windings 30 in an axial direction. Therefore, in these embodiments, the shroud 60 is not a unitary monolithic component, but is instead provided by two or more arc-shaped components. These two or more arc-shaped components are inserted onto the core 20 and around the end turns 34 in a radial direction (e.g., the two components are moved onto the core 20 from opposite radial sides of the end turns 34). Once positioned on the core 20, the two or more arc-shaped components are welded or otherwise connected together to form the annular cover of the shroud 60.

In yet another embodiment, the undercut 78 may be provided by an annular shim 79 such as that shown in FIG. 17. In this embodiment, the annular shim 79 is positioned against the core 20 and between the outer circumferential wall 72 and the end turns 34. The annular shim 79 is also comprised of a non-conductive material and abuts or is connected to the outer circumferential wall 72. A small gap is provided between the shim 79 and the end turns 34 to allow for the flow of oil around the end turns. Accordingly, the annular shim 79 has a trapezoid-like cross-sectional shape with an outer side that abuts and follows the shape of the outer circumferential wall 72, and an inner side that is separated from but follows the shape of the end turns 44. The shim 79 may be provided as two or more arc-shaped components that are inserted onto the core 20 and around the end turns 34 in a radial direction. The components of the annular shim 79 are secured to the back iron 21 of the stator core 20. Once she shim 79 is in place the circumferential outer wall 72 of the shroud may be slid over the shim 79 in an axial direction. Together, the circumferential wall 72 and the shim 79 form the outer wall of the shroud 60.

It will be recognized that the undercut 78 is provided to maintain a relatively small clearance between the shroud 60 and the end turns 34, thus improving the cooling performance of the stator. While the clearance between the shroud 60 and the end turns has been described herein as being constant (within some margin of tolerance), it will be noted that this clearance may be different in different parts of the windings. For example, in some embodiments, the shroud may fit closer at the ID (e.g., 0.5 mm-1.0 mm clearance) than at the OD (e.g., 0.9 mm-3.0 mm clearance). In any event, because the shroud 60 closely hugs the end turns 34, the shroud facilitates continuous flow of the oil over the entire length of the end turns, and prevents excessive flow within the shroud at locations removed from the end turns.

### Circumferential Channels on OD of Stator Core

As discussed previously herein, the lamination stack that provides the stator core 20 may be provided by sheets of the magnetic-permeable material having different/alternating OD sizes, thus resulting in circumferential OD channels formed around the core 20. With reference to FIGS. 18A and 18B, a portion of an OD 26 of the stator core 20 is shown in cross-section to illustrate the circumferential OD channels 27. The lamination stack includes sheets 25a having a smaller OD (which may also be referred to herein as “small lams”) arranged between sheets 25b having a larger OD (which may also be referred to herein as “large lams”). Stacks of one or more small lams 25a alternate with stacks of one or more large lams 25b on the core 20. This results in a finned lamination stack wherein the large lams 25b form fins around the OD, and the circumferential OD channels 27 are formed between the fins. More specifically, the fins are provided by the large lams 25b and the OD channels 27 are formed radially-outward from the small lams 25a.

The OD channels 27 are designed to be wide enough and deep enough to allow oil-flow around the OD of the stator, and thus provide increased cooling area. However, at the same time, the OD channels 27 are also designed to be small enough to force oil flow into other areas. In other words, the OD channels 27 are small enough such that they do not starve oil flow in some areas of the stator cooling path. In at least some embodiments, the OD channels 27 are about six (6) lams wide (i.e., six small lams 25a are stacked adjacently together and bookended by two large lams 25b) and about 4.0 mm deep (e.g., the small lams 25a may be about 8.0 mm OD less than the large lams 25b). In such embodiment, the laminations may be 0.27 mm thick (in the axial direction), so the OD channels 27 are about 1.62 mm wide (in the axial direction) (i.e., 0.27×6=1.62). Similarly, the fins may also be formed from a stack of six (6) large lams 25b, such that the fins have a similar width as the OD channels 27. In at least some embodiments, the OD channels 27 are in a range of three (3) to nine (9) lams wide.

### Flow Paths for Cooling Fluid

With reference now to FIGS. 19-22 different embodiments of the stator 12 are disclosed wherein each embodiment includes a different flow path for cooling fluid (which flow paths may also be referred to herein as “cooling paths”). In each of the embodiments of FIGS. 19-22, the stators are illustrated with the center axis 18 extending horizontally across the page such that the crown-end 14 of the stator is illustrated on the left side of the figure, and the lead-end 16 of the stator is illustrated on the right side of the figure (i.e., the axial direction of the stator 12 is left-to-right and right-to-left). This exemplary orientation is a common orientation when the stator 12 is used in an electric machine for an electric motor vehicle.

A first embodiment of a flow path 100 for cooling fluid is shown in association with FIGS. 19 and 20. FIG. 19 shows a first cross-sectional view of the stator 12 (e.g., through the plane defined by axes 17 and 18 of FIG. 3) to illustrate several inlets and outlets of the flow path 100 for the stator 12 and the associated direction of fluid flow. FIG. 20 shows another cross-sectional view of the stator 12 rotated about 90° degrees around the central axis relative to FIG. 19 (e.g., through the plane defined by axes 18 and 19 of FIG. 3) in order to illustrate the direction of fluid flow at positions on the stator that are removed from the inlets and outlets.

As shown in FIG. 19, a fluid inlet 102 is positioned at the top of the stator (i.e., at a first radial location) between the crown end 14 and the lead end 16 of the stator 12. The fluid inlet 102 extends through the housing 15 and is configured to receive a pressurized flow of oil or other cooling fluid, as indicated by arrow 104. The fluid inlet 102 leads to a first/top axially-extending cavity 106 formed within the housing 15. The top axially-extending cavity 106 is radially inward from the walls of the housing 15 and is adjacent to the stator core 20. This top axially-extending cavity 106 is connected to each of the channels 27 formed along the OD of the stator core 20. The channels 27 extend circumferentially around the OD, in the clockwise (CW) direction and in counter-clockwise (CCW) direction, between the fins 25 until they reach a second/bottom axially-extending cavity 108 that is opposite the top axially-extending cavity 106. Together, the first axially-extending cavity 106, the circumferential channels 27, and the second axially-extending cavity 108 define a first section of the flow path for the stator 12. In particular, fluid pumped into the top cavity 106 flows directly into the OD channels 27, and flows downward and circumferentially around the stator core 20 via the OD channels 27 as indicated by directional flow arrows 109 in FIG. 19. The fluid flows in the CW and CCW direction through the channels 27. The fluid then flows into the bottom cavity 108 and is forced axially outward to the shroud passages 110, 112 located on the opposite axial sides of the stator core 20.

The shroud passages 110, 112 are provided by small circumferential portions of the shrouds 60, 80 that are not connected to the stator core 20. As described previously, the circumferential outer lips of the shrouds (i.e., 74 and 98 of shrouds 60 and 80, respectively) are connected to the back iron 21 of the stator core 20. This connection extends around substantially all of the circumferential outer lips 74, 98 (e.g., around 355°, but not a complete 360°). However, a small portion of each circumferential lip 74 (e.g., a 5° arc) 98 is not connected to the core 20 and instead is connected to the housing 15, as noted at shroud-housing connection 111 at the bottom of the stator of FIG. 19. Accordingly, the pressurized fluid in the axially-extending cavity 108 is forced axially outward and through the shroud passages 110, 112 at this bottom position.

Fluid flowing through the shroud passages 110, 112 enters the respective shroud cavities 116, 118 formed by the shrouds 60, 80. Because the shrouds 60, 80 are sealed against the stator core 20 and against the center sleeve 50, the shroud cavities 116, 118 are liquid-tight and do not permit cooling fluid to escape from the shroud cavities 116, 118 except for through the designated inlet/outlet areas, including the shroud passages 110, 112 and the fluid outlet ports 120, 122. The fluid outlet ports 120, 122 are positioned at the top of the stator 12 and may be provided by ports that are incorporated into the walls of the shrouds 60, 80, such as fluid inlet/outlet port 78 (as shown in FIG. 11 and described in association with the crown-end shroud 60). Cooling fluid flowing within the shrouds is directed over the end turns 34 of the windings 30 (i.e., the winding heads 36) and generally upward and circumferentially through the shroud cavities 116, 118, and toward the fluid outlet ports 120, 122, as indicated by arrows 117, 119 of FIGS. 19 and 20. These shroud cavities 116, 118 define second and third sections of the flow path for the stator 12. It will be recognized that the fluid in the channels 27, flows in series with the fluid in the shrouds 110 and 112 (i.e., the first section is in series with the second and third sections). The fluid in shroud 110 flows in parallel with the fluid in shroud 112 (i.e., the second and third sections are in parallel).

The fluid outlet ports 120, 122 of the shrouds 60, 80 are sealed to fluid outlets 124, 126 of the housing 15. Like the fluid inlet 102, the fluid outlets 124, 126 in the housing 15 are also positioned at the top of the stator 12 and extend through the housing 15. The fluid outlets 124 and 126 are positioned on opposite axial ends of the stator 12 and receive the pressurized fluid exiting the shrouds 60, 80. After passing through the fluid outlets 124, 126 of the housing, the cooling fluid is cooled within a cooling system associated with the electric machine. For example, the cooling fluid may be directed across a vehicle radiator in order to release heat from the fluid and cool the fluid. Thereafter, the fluid is returned to the fluid inlet 102 and recycled again through the various sections of the cooling flow path (i.e., through the cylindrical cavity 106 around the housing, and then through the shroud cavities 116, 118).

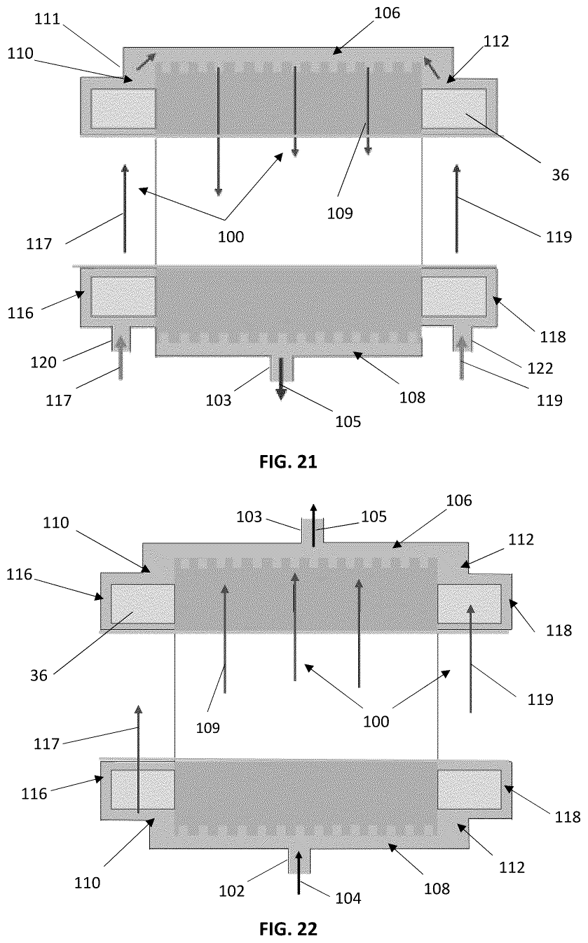

FIG. 21 shows a second embodiment of a flow path 100 for cooling fluid within the stator. As shown in FIG. 21, the inlets and outlets are on the bottom of the stator (as opposed to the top as with FIGS. 19 and 20), and the fluid path is reversed from what is shown in FIGS. 19 and 20. The fluid inlet ports 120, 122 lead directly into the shroud cavities 116, 118. The cooling fluid then flows upward and circumferentially around the end turns 34 of the winding arrangement 30, as indicated by directional flow arrows 117, 119. After reaching the top of the stator core 20, the fluid flows through the shroud passages 110, 112 and is directed into the top axially-extending cavity 106 within the housing 15. The fluid in the cavity 106 then flows downward within the channels 27 and circumferentially around the stator core 20, to the bottom axially-extending cavity 108. The fluid then flows to the bottom fluid outlet 103. After reaching the fluid outlet 103, the fluid exits the stator, as indicated by arrow 105 and is cooled within the cooling system associated with the electric machine, and the fluid is then returned to the fluid inlet ports 120, 122 and recycled again through the various sections of the cooling flow path. The first and second embodiments of FIGS. 19-21 may be considered to provide “series” flow paths because a single liquid input provides a flow path that includes a first section that extends circumferentially around the stator core and is then split into two additional sections connected in series with the first section (i.e., a second path section through shroud cavity 116 and a third path section through shroud cavity 118), and separate liquid outputs are provided for each of the two additional sections at opposing ends of the stator (as shown in FIGS. 19-20, or vice-versa wherein two liquid inputs are combined into one liquid output as shown in FIG. 21).

FIG. 22 shows a third embodiment of a flow path 100 for cooling fluid within the stator. In FIG. 22, the fluid inlet 102 is positioned at the bottom of the stator (i.e., at a first radial location) between the crown end 14 and the lead end 16 of the stator 12. Similarly, a fluid outlet 103 is positioned 180° opposite the fluid inlet 102 at the top of the stator. No fluid inlets or fluid outlets are included on the shrouds 60, 80. Instead both the top and the bottom of the stator include shroud passages 110, 112 that allow oil to flow out of and into the top and bottom axially-extending cavities 106, 108. In operation, pressurized oil enters the bottom axially-extending cavity 108 through the fluid inlet 102 as indicated by arrow 104. The oil then flows upward through the cavities 27 around the cylindrical stator core, as indicated by flow path arrows 109. At the same time (i.e., in parallel with the flow through the cavities 27), the pressurized oil flows into the shroud cavities 116, 118 and then upward around the winding heads 36, as indicated by flow path arrows 117, 119. The oil in the shroud cavities 116, 118 then enters the top axially-extending cavity 106. The pressurized oil is then forced out of the fluid outlet 103, as indicated by arrow 105 and is cooled within the cooling system associated with the electric machine. The cooled oil is then returned to the fluid inlet 102 and recycled again through the various sections of the cooling flow path. This third embodiment may be considered to provide a “parallel” flow path because one liquid input provides a flow path including a first section that extends circumferentially around the stator core and is then split into two additional sections (i.e., a second path section through shroud cavity 116 and a third path section through shroud cavity 118), wherein the two additional sections are then joined at a fourth section (i.e., a section that extends along the stator core) before exiting at one liquid output. In other words, the second and third sections are formed in parallel between the first and fourth sections of the flow path.

In addition to different possible embodiments of cooling flow paths 100 for the stator 12, the diamond shaped coils 40 and shape of the shrouds 60, 80 further facilitate cooling of the stator 12. Specifically, when the windings 30 of the stator 12 include diamond shaped coils 40, the structure of the shrouds 60, 80 is such that the shrouds cause the cooling fluid in the shroud cavities 116, 118 to closely hug the conductors of the end turns 44, thus resulting in improved cooling of the end turns. In particular, the corrugated radial face 62 of the crown-end shroud 60, and the internal lead grate 82 of the lead-end shroud 80 include features that cause the cooling fluid to regularly flow across the conductors that form the end turns 44 of the diamond shaped coils 40. Moreover, the diamond shape of the coils 40, including the eyelet holes 47 formed by the rounded tips 46 of the end turns 44, also improves fluid flow across the end turns. The fluid flow is also provided with an increased velocity, thereby improving heat transfer from the conductors of the winding arrangement 30 to the cooling fluid.

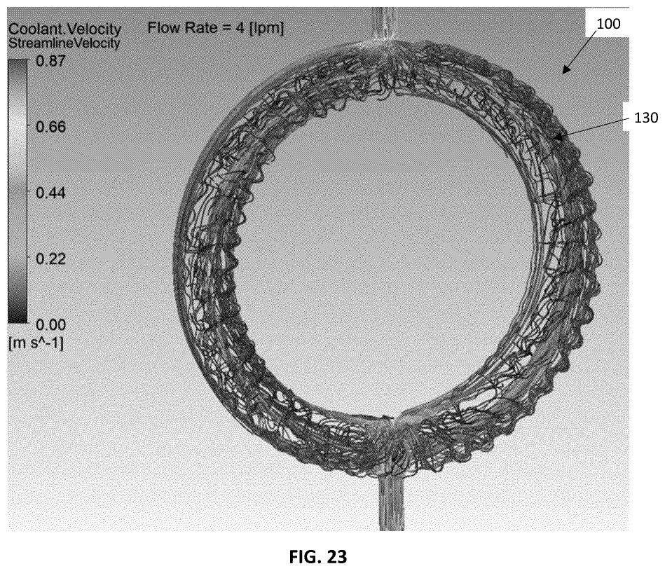

FIG. 23 shows a heat map of coolant velocity within the shroud cavity (i.e., a segment of the flow path 100) at the crown-end of the stator core. As shown in FIG. 23, the fluid flowing through the shroud cavity is generally torus-shaped. The flow rate is relatively constant throughout the torus. However, a ring 130 of improved velocity is clearly identified within the torus shape. This ring 130 represents the increased velocity of fluid that flows through the eyelet holes 47 of the end turns 44.

It will be recognized from the figures and the foregoing text that a flooded stator with improved cooling effects is disclosed herein. The stator includes a flow path for cooling fluid that is comprised of several sections, including a section provided by a cylindrical cavity that surrounds the stator core and additional sections provided by shroud cavities at opposite axial ends of the stator. The flow path provides a series flow of cooling fluid that extends through the cylindrical cavity and then floods end turns at opposing axial ends of the stator core (or vice-versa). In at least some embodiments, the stator winding is formed of diamond coils. Diamond coils include a significant surface area and have an eyelet hole in the middle of the end loop. Other winding configurations (e.g., hairpin, continuous hairpin . . . etc.) do not include such eyelet holes. With the flooded stator and diamond coils disclosed herein, the oil flows in a circular pattern though each eyelet hole, and provides increased cooling effects to the windings. The shrouds fit closely to the end turns to force the oil to flow through the eyelet holes. The shrouds further include axial bumps/ridges which will fit into or roughly into the space between the end loops of the diamond coils. These bumps cause the oil flow to meander in and out of the peaks of the diamond coil end loops, thus resulting in higher surface area exposure and better cooling of the end loops. Furthermore, because the cooling oil takes the easiest path to flow, the close proximity of the shrouds to the end turns results in the easiest flow through the eyelets. The flow of oil through the eyelets therefore has a higher velocity than that found in other flow paths. Because the HTC (heat transfer coefficient) is so improved with a flooded diamond cooling design, the oil outlet might be too hot. To compensate for the increased HTC, the flow rate of the oil may be increased. For example, with typical oil cooling the flow rate may be around 1-2 liters-per-minute (LPM), but with the flooded stator disclosed herein a flow rate of 3-5 LPM is more desirable for the HTC, as this results in cooler oil temperature and cooler stator end turns.

Although the various embodiments have been provided herein, it will be appreciated by those of skill in the art that other implementations and adaptations are possible. For example, to help cool the wire segments in the stator core, the lamination may be comprised of two halves which are spaced a part from each other. Such a split lamination stack will allow some of the oil to flow in between the two halves and reach the wires located in the center of the stack. As another example, in at least some embodiments, cooling oil may also be allowed to flow from one axial end to the other axial end of the stator slots (e.g., between the inner most wire and the inner sleeve), thus providing additional cooling the conductors of the winding arrangement. Of course, numerous other examples of adaptations and different embodiments of the stator core are contemplated. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. A liquid-cooled stator comprising:
a housing;
a stator core positioned within the housing, the stator core including a plurality of teeth and a back iron, the plurality of teeth defining an inner diameter (ID) of the stator core, and the back iron defining an outer diameter (OD) of the stator core;
a winding arrangement positioned on the stator core, the winding arrangement including a first plurality of end turns extending from a first axial end of the stator core and a second plurality of end turns extending from a second axial end of the stator core;
a shroud positioned on the first axial end of the stator core and covering the first plurality of end turns; and
an inner sleeve connected to the ID of the stator core, the inner sleeve extending in an axial direction beyond a first axial end of the stator core.

2. The liquid-cooled stator of claim 1 wherein the shroud is connected to the inner sleeve in proximity of the first axial end of the stator core.

3. The liquid-cooled stator of claim 2 wherein the shroud is welded to the inner sleeve in proximity of the first axial end of the stator core.

4. The liquid-cooled stator of claim 2 wherein an adhesive is used to connect the shroud to the inner sleeve in proximity of the first axial end of the stator core.

5. The liquid cooled stator of claim 4 wherein the adhesive is a cured B-stage epoxy on the inner sleeve.

6. The liquid-cooled stator of claim 2 wherein the shroud is a first shroud, the stator further comprising a second shroud positioned on the second axial end of the stator core and covering the second plurality of end turns, the second shroud connected to the inner sleeve in proximity of the second axial end of the stator core.

7. The liquid-cooled stator of claim 6, the first shroud including an inner lip that is welded to the inner sleeve, and the second shroud including an inner lip that is connected to the inner sleeve.

8. The liquid-cooled stator of claim 1 wherein the inner sleeve includes an outer annular surface that is coated with an adhesive, wherein the outer annular surface of the inner sleeve is connected to the ID of the stator core with the adhesive.

9. The liquid-cooled stator of claim 8 wherein the inner sleeve is formed from a fluid-impervious sheet that is rolled into a cylindrical shape and adhered to the ID of the stator core.

10. The liquid-cooled stator of claim 1 further comprising a support ring connected to the shroud, the support ring including an axially-outward lip connected to an axially-outward surface of the of the shroud and a cylindrical portion that engages an inner annular surface of the inner sleeve.

11. A liquid-cooled stator comprising:
a housing;
a stator core positioned within the housing, the stator core including a plurality of teeth and a back iron;
a winding arrangement positioned on the stator core, the winding arrangement including a plurality of end turns extending from an axial end of the stator core; and
a shroud positioned on the axial end of the stator core and covering the plurality of end turns, the shroud including a corrugated radial wall defining an axially-outward face.

12. The liquid cooled stator of claim 11, wherein the plurality of end turns include groups of radially-aligned end turns positioned around the axial end of the stator core, the corrugated radial wall defining a plurality of ridges and a plurality of grooves, wherein the plurality of ridges are positioned over the radially-aligned end turns and the plurality of grooves are positioned between the radially-aligned end turns, wherein the stator core is provided by a lamination stack, wherein the OD of the stator core defines a plurality of circumferential channels extending around the stator core, the winding arrangement including a plurality of diamond shaped coils wherein the end turns comprise rounded tips with eyelets defined within the rounded tips.

13. The liquid-cooled stator of claim 11 further comprising an inner sleeve connected to an inner diameter (ID) of the stator core, wherein the shroud includes an inner perimeter lip connected to the inner sleeve.

14. The liquid-cooled stator of claim 11, the shroud including an outer perimeter lip connected to the stator core.

15. The liquid-cooled stator of claim 14 wherein the shroud further includes an undercut that extends radially inward at the outer perimeter lip such that a constant distance is maintained between the shroud and the end turns at both the corrugated radial wall and the undercut.

16. The liquid-cooled stator of claim 15 wherein the undercut is provided by a shim positioned radially inward from the outer perimeter lip.

17. A liquid-cooled stator comprising:
a housing;
a stator core positioned within the housing, the stator core including a back iron defining an outer diameter (OD) of the stator core and a plurality of teeth defining an inner diameter (ID) of the stator core and an inner cylindrical space;
a winding arrangement positioned on the stator core, the winding arrangement including a plurality of end turns extending from an axial end of the stator core, wherein the end turns bow radially-outward toward the OD; and
a shroud positioned on the axial end of the stator core and covering the plurality of end turns, the shroud including an undercut along an outer wall of the shroud in proximity of the stator core such that a radial distance from the inner cylindrical space to the outer wall of the shroud is less at the undercut than at positions axially-outward from the undercut.

18. The liquid-cooled stator of claim 17 wherein the shroud is an annular member comprised of at least two separate components.

19. The liquid cooled stator of claim 18 wherein the at least two separate components include at least two arc-shaped components that are connected to form the annular member.

20. The liquid cooled stator of claim 18 wherein the shroud includes an annular cover and at least one shim, wherein the annular cover comprises an axially-extending sidewall with the at least one shim abutting the axially-extending sidewall such that the axially-extending sidewall and the at least one shim together form the outer wall of the shroud.
